(19) United States
(12) Patent Application Publication
(10) Pub. No.: US 2013/0226325 A1
(43) Pub. Date: Aug. 29, 2013

(54) METHODS AND SYSTEMS FOR FABRICATING INTEGRATED CIRCUITS WITH LOCAL PROCESSING MANAGEMENT

(71) Applicant: Chinmay S. Oza, Ballston Spa, NY (US)

(72) Inventor: Chinmay S. Oza, Ballston Spa, NY (US)

(73) Assignee: GLOBALFOUNDRIES INC., Grand Cayman (KY)

(21) Appl. No.: 13/404,053

(22) Filed: Feb. 24, 2012

(51) Int. Cl. G06F 19/00

(52) U.S. Cl. 700/100; 901/50

(57) ABSTRACT

Methods and systems for fabricating integrated circuits are provided. In an embodiment, a method for fabricating integrated circuits includes hosting process recipes on a recipe management system (RMS). Processes are performed according to the process recipes on substrates with equipment units. Movement of substrates to and from equipments units is controlled with a local storage controller. A real time dispatcher (RTD) establishes a priority for processes on substrates. Further, a manufacturing execution system (MES) supervises locations of substrates and processes to be performed. Information is communicated to a local scheduler from the RMS, from each equipment unit, from the local storage controller, from the RTD, and from the MES. Based on the information, the local scheduler schedules movement of the substrates to and from the equipment units.

### TECHNICAL FIELD

The present disclosure generally relates to methods and systems for fabricating integrated circuits, and more particularly relates to methods and systems for fabricating integrated circuits with local processing management.

### BACKGROUND

In the global market, manufacturers of mass products must offer high quality devices at a low price. It is thus important to improve yield and process efficiency to minimize production costs. This holds especially true in the field of semiconductor fabrication, where it is essential to combine cutting-edge technology with volume production techniques. It is the goal of semiconductor manufacturers to reduce the consumption of raw materials and consumables while at the same time improving process tool utilization. The latter aspect is especially important since, in modern semiconductor facilities, equipment is required which is extremely cost intensive and represents the dominant part of the total production costs.

Integrated circuits are typically manufactured in automated or semi-automated facilities by passing substrates including the devices through a large number of process steps to complete the devices. The number and the type of process steps a semiconductor device has to go through may depend on the specifics of the semiconductor device to be fabricated. For instance, a sophisticated CPU may require several hundred process steps, each of which has to be carried out within specified process margins to fulfill the specifications for the device under consideration.

In a semiconductor facility, a plurality of different product types are usually manufactured at the same time, such as memory chips of different design and storage capacity, CPUs of different design and operating speed, and the like. The number of different product types may even reach a hundred or more in production lines for manufacturing ASICs (Application Specific ICs). Each of the different product types may require a specific process flow, and require different mask sets for lithography and specific settings in various process tools, such as deposition tools, etch tools, implantation tools, chemical mechanical polishing (CMP) tools and the like. Consequently, a plurality of different tool parameter settings and product types may be encountered simultaneously in a manufacturing environment. Thus, a mixture of product types, such as test and development products, pilot products, and different versions of products, at different manufacturing stages, may be present in the manufacturing environment at a time. Further, the composition of the mixture may vary over time depending on economic constraints and the like, since the dispatching of non-processed substrates into the manufacturing environment may depend on various factors, such as the ordering of specific products, a variable degree of research and development efforts and the like. Thus, frequently, the various product types may have to be processed with a different priority to meet requirements imposed by specific economic or other constraints.

Nevertheless, it remains an important aspect with respect to productivity to coordinate the process flow within the manufacturing environment in such a way that high efficiency of tool utilization is achieved. This is a critical cost factor due to the investment costs and the moderately low “life span” of semiconductor process tools, and is a significant component in the determination of the price of fabricated semiconductor devices.

Accordingly, it is desirable to provide methods and systems for fabricating integrated circuits that reduce process tool idle time and increase tool utilization by reducing time intervals between the completion of a processing step on a lot of substrates and the commencement of a processing step on a successive lot of substrates. It is also desirable to provide methods and systems for fabricating integrated circuits that utilize integrated local processing management of substrates to reduce process tool idle time. Furthermore, other desirable features and characteristics of the methods and systems for fabricating integrated circuits will become apparent from the subsequent detailed description and the appended claims, taken in conjunction with the accompanying drawings and this background.

### BRIEF SUMMARY

Methods and systems for fabricating integrated circuits are provided. In accordance with one exemplary embodiment, a method for fabricating integrated circuits includes hosting process recipes on a recipe management system (RMS). Processes are performed according to the process recipes on substrates with equipment units. Movement of substrates to and from equipments units is controlled with a local storage controller. A real time dispatcher (RTD) establishes a priority for processes on substrates. Further, a manufacturing execution system (MES) supervises locations of substrates and processes to be performed. Information is communicated to a local scheduler from the RMS, from each equipment unit, from the local storage controller, from the RTD, and from the MES. Based on the information, the local scheduler schedules movement of the substrates to and from the equipment units.

In another embodiment, a method for fabricating an integrated circuit employs local processing management. The method associates a local scheduler with a recipe management system (RMS), a real time dispatcher (RTD), a manufacturing execution system (MES), equipment hosts, and local storage controllers. Processes and movement of substrates are scheduled by the local scheduler based on information from the RMS, RTD, and MES. The substrates are moved to and from equipment units according to direction from the local storage controllers. The scheduled processes are performed by the equipment units according to direction from the equipment hosts.

In accordance with another exemplary embodiment, a system for fabricating integrated circuits is provided. The system includes a recipe management system (RMS) configured to host process recipes. Equipment units are configured to perform processes on substrates according to the process recipes and equipment hosts are configured to control processing by the equipment units. Further, local storage ports are configured to store substrates selected for processing near the equipment units, and local storage controllers are configured to control movement of the substrates to and from equipments units. The system includes a real time dispatcher (RTD) configured to establish a priority for processes performed on substrates. Also, a manufacturing execution system (MES) is configured to compile locations of substrates and processes to be performed. A local scheduler is provided with a communication link to the RMS, equipment hosts, local storage controller, RTD, and MES. The local scheduler is configured to schedule local movement of substrates and processing on substrates based on information communicated by the RMS, equipment hosts, local storage controller, RTD, and MES.

### BRIEF DESCRIPTION OF THE DRAWINGS

Exemplary embodiments will hereinafter be described in conjunction with the following drawing figures, wherein like numerals denote like elements, and wherein:

FIGS. 1-5 are schematic views of systems for fabricating integrated circuits in accordance with exemplary embodiments;

FIG. 6 is a flow chart representing the method performed by the systems of FIGS. 1-5.

### DETAILED DESCRIPTION

The following detailed description is merely exemplary in nature and is not intended to limit the methods and systems for fabricating integrated circuits as claimed herein. Furthermore, there is no intention to be bound by any theory presented in the preceding background or the following detailed description.

As detailed below, the methods and systems for fabricating integrated circuits utilize local processing management of substrates, or works-in-progress (WIP). Specifically, local substrate or WIP management units are used for single tools, or for groups of tools to provide improved scheduling, i.e., to reduce idle times for tools and to reduce and optimize transport times for substrates. The local management units are scalable across different types of tools and logic systems. As a result, the local management units may be utilized universally throughout a semiconductor fabrication facility (a “fab”) to provide the facility with a universal distributed management system. The local management units provide the ability to maintain multiple distributed process schedulers across tools having different manufacturers and associated software and logic. As a result, the inefficiencies of a centralized scheduler as well as those of unique dedicated tool schedulers are avoided. As a result of the “real time” schedule decision-making afforded the present method and system, exception management and inefficiency is minimized as the time window for exception events is minimized.

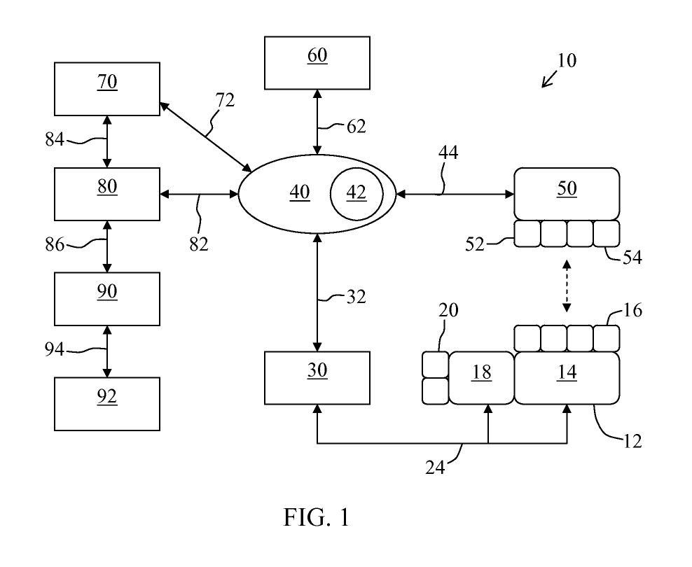

As shown in FIG. 1, the system 10 for fabricating integrated circuits incorporates a local processing management. As shown, the system 10 includes an equipment unit 12, which may be a process module or process tool for performing a fabrication process, a metrology process, a sorting process or a handling process. “Equipment unit” is used herein to refer to any process equipment, such as process modules and process tools, whether for fabricating, measuring, sorting, or handling. As used herein, a process may refer to a fabrication, metrology, sorting or handling process. The exemplary equipment unit 12 is a lithographic process tool and includes a track 14 provided with substrate ports 16 and a scanner 18 provided with reticle ports 20.

As further shown, equipment unit 12 is provided with a direct communication link 24 to an equipment interface (EI) or host controller (equipment host or host) 30. The host 30 has a direct communication link 32 to a local management unit 40. As shown, the local management unit 40 includes a local scheduler 42. The local management unit 40 communicates directly with the host 30 to receive equipment data. Further, the local management unit 40 is directly connected via link 44 with a local storage control 50, or buffer control unit. The local storage control 50 communicates with a local storage device 52, which may be a fixed buffer or internal buffer. As shown, the local storage device 52 includes a plurality of input/output ports 54 or buffer ports for receiving substrate carriers or reticle carriers. Further, the input/output ports 54 are arranged for interaction with equipment ports 16, and reticle ports 20, on the equipment unit 12. As a result, substrate carriers or substrates and reticle carriers or reticles may be exchanged between the equipment unit 12 and local storage device 52.

In system 10, the local management unit 40 continuously receives equipment and processing data from the host 30 which may include a predicted process completion time, the identity of substrate lots at the equipment unit 12, the number of steps remaining in a process at the equipment unit 12, the status of equipment ports 16 (whether vacant or occupied) at the equipment unit 12, the status of input/output ports 54 (vacant or occupied) at the local storage device 52, the identify of substrate lots at the local storage device 52, substrate temperature data, equipment temperature data, storage device temperature data, sensor information, process parameters, preventative maintenance data, carrier state information, substrate location and/or process data, and/or robot interlock information among other equipment and storage device information. The local management unit 40 further continuously receives local storage information or data from the local storage controller 50, including the status of input/output ports 54 (vacant or occupied) at the local storage device 52, the identify of substrate lots at the local storage device 52, storage device temperature data, substrate temperature data, sensor information, preventative maintenance data, carrier state information, and robot interlock information among other storage information. Such storage data may vary depending on the manufacturer of the local storage device 52.

As further shown, in the exemplary system 10, the local management unit 40 is directly connected to a recipe management system (RMS) 60 via a direct link 62. The RMS 60 hosts process recipes including process details and process parameters for all processes that may be performed by equipment units 12 on substrates in the fab. The RMS 60 continuously communicates selected process recipe information to the local management unit 40 where it can be forwarded to the appropriate equipment host 30 for processing.

Also, the local management unit 40 is directly connected to a real time dispatcher (RTD) 70 by a direct link 72. The real time dispatcher 70 establishes the fab-wide priority for processes performed on substrates. As shown, the local management unit 40 is further connected to a manufacturing execution system (MES) 80 by a direct link 82. The MES 80 supervises and compiles locations of substrates and the remaining processes to be performed on those substrates. As shown, the MES 80 and RTD 70 are also directly connected by a link 84 so that they may communicate information to one another. Also, the MES 80 is directly connected by link 86 to a material control system (MCS) 90. Further, the MCS 90 directly communicates with an automated material handling system (AMHS) 92 such as an overhead transport system by link 94. The AMHS 92 is configured to transport substrates to the buffer ports 54, or equipment ports 16, throughout the fab. Through these connections, the MES 80 is able to track and compile the substrate location and process information. In the system 10, the RTD 70 continuously communicates the fab-wide processing priority to the local management unit 40. Further, the MES 80 continuously communicates the substrate location and process information to the local management unit 40.

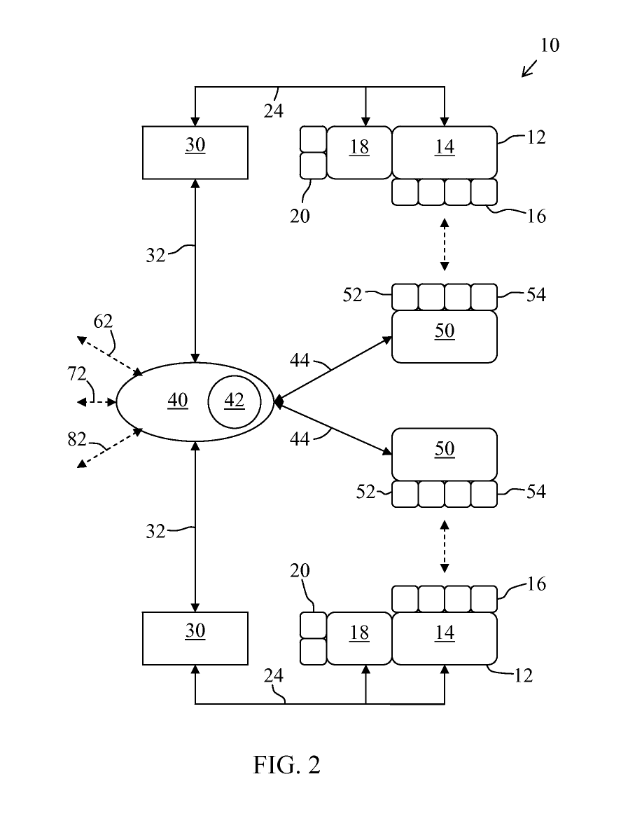

FIGS. 2-5 illustrate alternative systems 10 for fabricating integrated circuits. It is noted that FIGS. 2-5 do not include the devices connected through links 62, 72, and 82 merely for purposes of clarity. The alternative systems 10 do include the various devices 60, 70, 80, 90, and 92 and interconnections therebetween similarly to the system 10 of FIG. 1.

In FIG. 2, the system 10 is provided with multiple hosts 30 and local storage controllers 50. As shown, each respective host 30 and local storage controller 50 is assigned to an equipment unit 12, including tracks 14 and scanners 18. In such a system 10, the local management unit 40 is able to continuously receive and transmit information from and to each host 30 and local storage controller 50. Further, each host 30 continuously communicates with its associated track 14 and scanner 18.

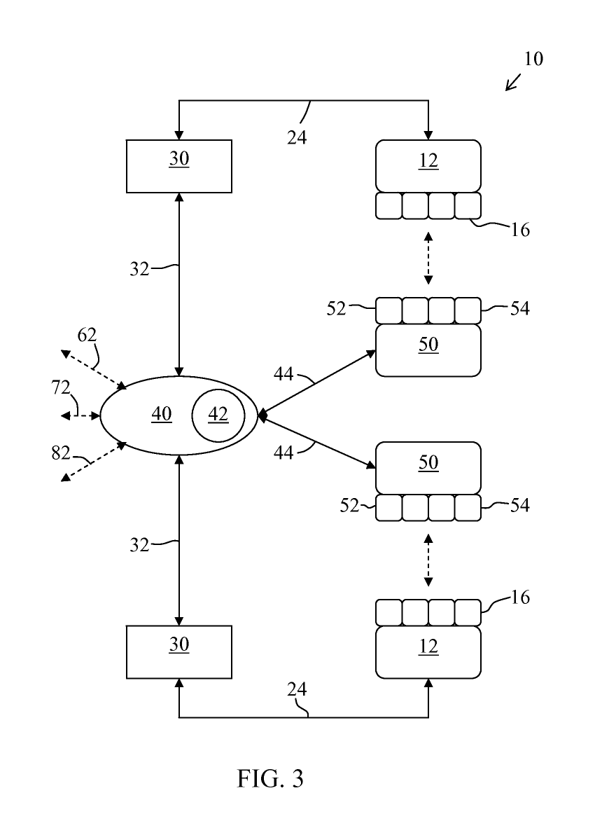

The system 10 in FIG. 3 is similar to that of FIG. 2, but clarifies that any tool may be used as equipment unit 12, including non-lithographic units that lack tracks 14 and scanners 18. Again, the system 10 includes multiple hosts 30 and local storage controllers 50. As shown, each respective host 30 and local storage controller 50 is assigned to an equipment unit 12. In such a system 10, the local management unit 40 is able to continuously receive and transmit information from and to each host 30 and local storage controller 50. Further, each host 30 continuously communicates with its associated equipment unit 12.

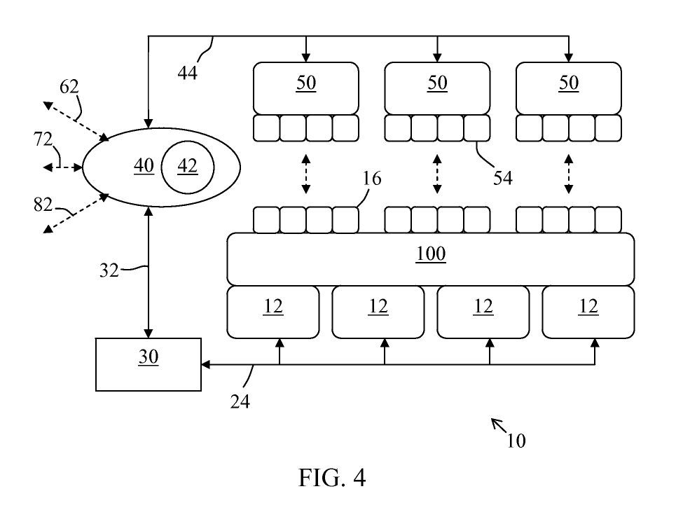

Referring now to FIG. 4, another arrangement of the system 10 is shown. In FIG. 4, a plurality of equipment units 12 in the form of process modules, are arranged and assembled in an Equipment Front End Module (EFEM) 100. As shown, the EFEM 100 is provided with equipment ports 16 that are linked to the equipment units 12 through the EFEM 100. During processing, substrates may be loaded at one of the equipment ports 16 and delivered to an equipment unit 12 through the EFEM's internal wafer handling mechanism. In arranging the EFEM 100, equipment ports 16 may be identified for dedicated service to a specific equipment unit 12. However, in operation, any equipment port 16 may be used to deliver or remove substrates from a particular equipment unit 12. Further, each equipment unit 12 is connected to the host 30 by link 24. The host 30, in turn, is connected to the local management unit 40 through link 32. In FIG. 4, a single host 30 is associated with pluralities of equipment units 12, rather than with single equipment units 12, though either arrangement may be used in system 10. As shown, the system 10 further includes local storage controllers 50 that direct movement of substrates between storage ports 54 and equipment ports 16.

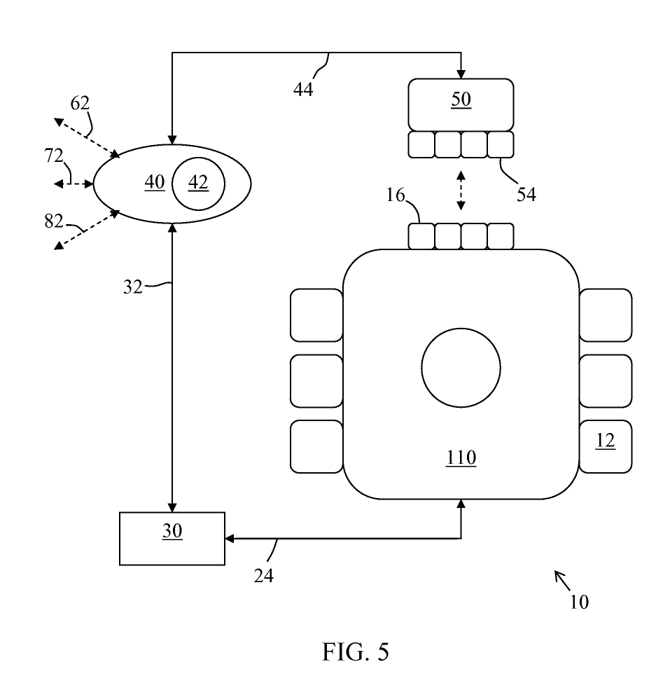

FIG. 5 depicts a system 10 for use with a clean tunnel transport arrangement 110. As shown, a plurality of equipment units 12, such as process modules, are connected to the clean tunnel arrangement 110. Also, the arrangement 110 includes equipment ports 16 for receiving, dispatching, and transporting substrates for the equipment units 12. Further, the clean tunnel arrangement 110 is connected to the host 30 by link 24. The host 30 is connected to the local management unit 40 by link 32. In FIG. 5, a single local storage controller 50 is provided with ports 54 for transporting substrates to and from the equipment ports 16. However, multiple local storage controllers 50 may be used. As shown, the local storage controller 50 in connected to the local management unit 40 by link 44. Again, continuous communication of information from the units 12, 110, 30, and 50 to the local management unit 40 is contemplated.

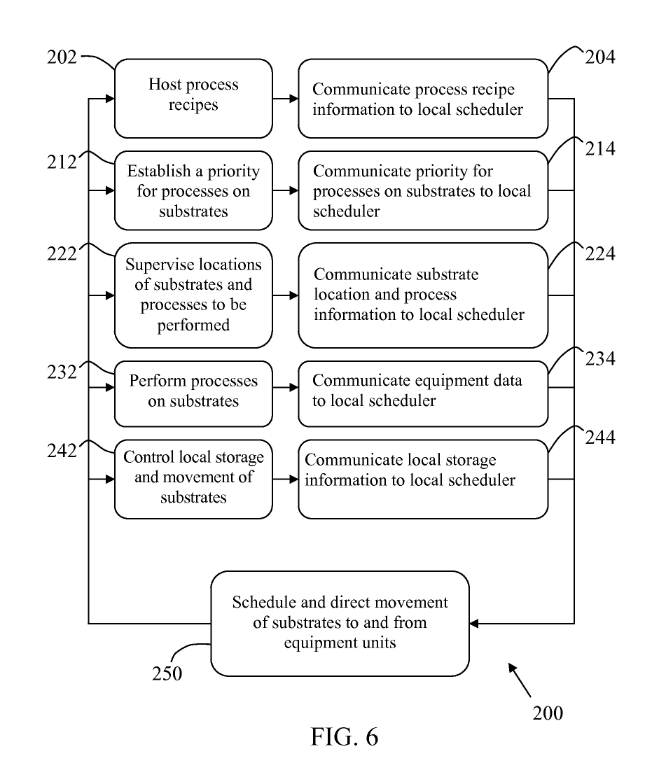

Referring to FIG. 6, an exemplary method 200 for fabricating integrated circuits with the system 10 is illustrated. As the method 200 operates in a steady state fashion, the steps are not linear, but occur continuously and in response to one another. In the illustration step 202 provides for hosting the process recipes on the RMS. Process recipe information is communicated from the RMS to the local scheduler in the local management unit in step 204, either in response to a query from the local management unit or independently. At step 212, the RTD establishes a priority for processes to be performed on substrates for the entire fab. The priority is continuously updated or revised by the RTD as it receives inputs from other units, such as through the MES or through the local management unit. At step 214, the processing priority is communicated to the local management unit.

As shown, step 222 provides for supervising the locations of substrates and processes to be performed on the substrates by the MES. The MES performs this continuous operation by receiving data from the RTD, the MCS, and the AMHS transport system. The substrate location and process information is communication from the MES to the local management unit at step 224. At step 232, processes are performed on substrates, such as a fabrication process like photolithography, etching, cleaning, doping, dicing or other typical semiconductor fabrication processes, metrology processes, sorting processes, or handling processes. Equipment data is continuously communicated from the equipment unit through the hosts to the local management unit at step 234. The equipment data may include the identity of substrate lots at the equipment unit, the number of steps remaining in the current process for a substrate or substrate lot, the status of equipment ports (whether vacant or occupied) at the equipment unit, a predicted process completion time for the substrate lot currently undergoing processing, substrate temperature data, equipment temperature data, sensor information, sensor status, process parameters, preventative maintenance data, carrier state information, substrate location and/or process data, robot interlock information, status of internal automation components, and/or digital inputs among other equipment information. Such equipment data may vary depending on the manufacturer of the equipment unit.

The local storage controllers control local storage and movement of substrates to and from equipment units for processing at step 242. The local storage controllers continuously communicate local storage data at step 244. The local storage data may include the status of input/output ports (vacant or occupied) at the local storage device, the identify of substrate lots at the local storage device, storage device temperature data, substrate temperature data, sensor information, preventative maintenance data, carrier state information, and robot interlock information among other storage information. Such storage data may vary depending on the manufacturer of the local storage device.

Based on the information continuously received by the local management unit, the local scheduler schedules local movement of substrates to and from equipment units and communicates the schedule to the local storage control at step 250. In response, the local storage control directs removal of processed lots of substrates from equipment units and delivery of lots of substrates for processing by the equipment units.

As a result of the amount and type of information provided to the local scheduler, and the reduced number of steps and exchanges in communicating that information, the system 10 of FIGS. 1-5 is able to efficiently move substrates to and from the equipment units in less than 10 seconds, such as in less than 5, 3 or 1 second(s), and in exemplary embodiments in the order of milliseconds of the completion of their processing. Further, the system 10 of FIG. 3 is able to deliver new substrates from the local storage device 52 to the equipment unit 12 in less than 10 seconds, such as in less than 5, 3, or 1 second(s), and in exemplary embodiments in the order of milliseconds, of the completion of processing on a preceding lot of substrates. It is noted that the system 10 may be used both to manage movement of substrate carriers to and from process equipment units and/or to manage movement of wafer substrates to and from process modules, concurrently. As a result, movement of substrate carriers and substrates is managed at the millisecond level.

In view of the various illustrated embodiments, a fabrication facility may incorporate different embodiments for local processing management across different fabrication sectors or for different types of equipment units and hosts. Also, the information provided to the local management units allows for specialized treatment of substrate lots and carriers by the local storage device and equipment units. For instance, a substrate lot is typically delivered to and removed from equipment units in associated substrate carriers. In the present method and system, the local management unit may provide a schedule which requires the disassociation of substrates from a substrate carrier. As a result, a substrate carrier can be removed from an equipment port while its formerly associated substrates remain in the equipment unit. This ability is particularly appealing when substrate carriers hold varying numbers of substrates, and allows for increase throughput at the equipment unit, as an equipment port is available to receive another substrate carrier. The local management unit may then assign the disassociated substrates to a new substrate carrier, join the disassociated substrates to another substrate lot, or re-associate the substrates with their former carrier.

Accordingly, methods and systems for fabricating integrated circuits with integrated local processing management have been provided. From the foregoing, it is to be appreciated that the exemplary embodiments of the methods and systems for fabricating integrated circuits provide for reduced idle time of equipment units between completion of a process on substrates and commencement of processing a successive lot of substrates. Further, the exemplary embodiments of the methods and systems for fabricating integrated circuits schedule removal of processed substrates and delivery of new substrates to the equipment unit synchronized with the completion of processing on the preceding substrate or lot of substrates.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the methods and systems for fabricating integrated circuits in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the appended claims and their legal equivalents.

What is claimed is:

1. A method for fabricating integrated circuits comprising:
hosting process recipes on a recipe management system (RMS);
performing processes according to the process recipes on substrates with equipment units;
controlling movement of substrates to and from equipments units with a local storage controller;
establishing a priority for processes on substrates by a real time dispatcher (RTD);
supervising locations of substrates and processes to be performed by a manufacturing execution system (MES);
communicating to a local scheduler, information from the RMS, from each equipment unit, from the local storage controller, from the RTD, and from the MES; and
scheduling movement of the substrates to and from the equipment units by the local scheduler based on the information.

2. The method of claim 1 wherein communicating comprises communicating to the local scheduler: information including process recipe information from the RMS, processing data from each equipment unit, local storage information from the local storage controller, the priority for processes on substrates from the RTD, and substrate and process information from the MES.

3. The method of claim 2 wherein communicating comprises communicating to the local scheduler process recipe information including process details and process parameters.

4. The method of claim 2 wherein communicating comprises communicating the processing data directly from each equipment unit to a respective host.

5. The method of claim 4 wherein communicating comprises communicating the information directly to the local scheduler by the RMS, each host, the local storage controller, the RTD, and the MES system.

6. The method of claim 4 wherein communicating comprise communicating the local storage information including the status of storage ports.

7. The method of claim 4 wherein communicating comprises communicating the substrate and process information including the location of substrates in transit and in queues and the identity of processes to be performed on each substrate.

8. The method of claim 1 further including communicating the priority and the supervised locations between the RTD and the MES.

9. A method for fabricating integrated circuits employing local processing management comprising:
associating a local scheduler with a recipe management system (RMS), a real time dispatcher (RTD), a manufacturing execution system (MES), equipment hosts, and local storage controllers;
scheduling processes and movement of substrates by the local scheduler based on information from the RMS, RTD, and MES;
moving the substrates to and from equipment units according to direction from the local storage controllers; and
performing the scheduled processes by the equipment units according to direction from the equipment hosts.

10. The method of claim 9 wherein each equipment unit communicates processing data to a respective equipment host, and wherein scheduling further comprises scheduling processes and movement of substrates by the local scheduler based on the processing data.

11. The method of claim 9 wherein each equipment unit communicates processing data to a respective equipment host, and wherein scheduling further comprises scheduling processes and movement of substrates by the local scheduler based on the processing data, wherein the processing data is selected from the group comprising predicted process completion time, sensor information, temperature data, process parameters, preventative maintenance data, carrier state information, substrate location, and robot interlock data.

12. The method of claim 9 wherein local storage controllers communicate storage information to the local scheduler, and wherein scheduling further comprises scheduling processes and movement of substrates by the local scheduler based on the storage information.

13. The method of claim 9 wherein local storage controllers communicate storage information to the local scheduler, wherein scheduling further comprises scheduling processes and movement of substrates by the local scheduler based on the storage information, and wherein the storage information includes the status of storage ports.

14. The method of claim 9 further comprising establishing a priority for processes on substrates with the RTD, wherein the priority includes an optimized substrate sequence, and wherein scheduling comprises scheduling processes and movement of substrates by the local scheduler based on the optimized substrate sequence from the RTD.

15. The method of claim 9 further comprising:
establishing a priority for processes on substrates with the RTD;
compiling substrate location information with the MES; and
communicating the established priority and the compiled substrate location information between the RTD and the MES;
wherein scheduling comprises scheduling processes and movement of substrates by the local scheduler based on the established priority from the RTD and the compiled substrate location information from the MES.

16. The method of claim 9 wherein scheduling comprises scheduling processes and movement of substrates by the local scheduler based on information including process recipes hosted by the RMS, a priority for processes on substrates established by the RTD, and substrate location information compiled by the MES.

17. The method of claim 9 wherein scheduling comprises scheduling processes and movement of substrates by the local scheduler based on information including process recipes hosted by the RMS, and wherein the process recipes include process details and process parameters.

18. The method of claim 9 wherein associating comprises forming a direct communication link between the local scheduler and the RMS, RTD, MES, equipment hosts, and local storage controllers.

19. The method of claim 9 further comprising forming direct communication links between equipment hosts and equipment units.

20. A system for fabricating integrated circuits comprising:
a recipe management system (RMS) configured to host process recipes;
equipment units configured to perform processes on substrates according to the process recipes;
equipment hosts configured to control processing by the equipment units;
local storage ports configured to store substrates selected for processing near the equipment units;
a local storage controller configured to control movement of the substrates between equipments units and local storage ports;
a real time dispatcher (RTD) configured to establish a priority for processes performed on substrates;
a manufacturing execution system (MES) configured to compile locations of substrates and processes to be performed; and
a local scheduler having a communication link to the RMS, equipment hosts, local storage controller, RTD, and MES, wherein the local scheduler is configured to schedule local movement of substrates and processing on substrates based on information communicated by the RMS, equipment hosts, local storage controller, RTD, and MES.
